(19) United States
(12) Patent Application Publication
(10) Pub. No.: US 2019/0188581 A1
(43) Pub. Date: Jun. 20, 2019

(54) SWITCHING FROM CALENDAR-BASED TO PREDICTIVE MAINTENANCE: A LEANER AND FASTER SOFTWARE-BASED SOLUTION ORCHESTRATING DATA-DRIVEN FORECASTING MODELS

(71) Applicant: Siemens Aktiengesellschaft, Munich (DE)

(72) Inventors: Guillaume Chabin, Princeton Junction, NJ (US); Ioannis Akrotirianakis, Princeton, NJ (US); Amit Chakraborty, East Windsor, NJ (US)

(21) Appl. No.: 15/844,728

(22) Filed: Dec. 18, 2017

(51) Int. Cl. G06N 5/04; G06N 99/00

(52) U.S. Cl. CPC G06N 5/04; G06N 99/005

(57) ABSTRACT

A computer-implemented method for performing predictive maintenance includes executing a fleet prediction process. During this fleet prediction process, a plurality of fleet data records is collected. Each fleet data record comprises sensor data from a particular physical component in a fleet of physical components. A plurality of component maintenance predictions related to the fleet of physical components is generated. Each component maintenance prediction corresponds to a particular physical component. The plurality of component predictions are merged into one or more fleet maintenance predictions and the fleet maintenance predictions are presented to one or more users. Following the fleet prediction process, a next execution of the fleet prediction process is scheduled based on the fleet maintenance predictions.

### TECHNICAL FIELD

The present disclosure relates to systems, methods, and apparatuses that enable the switch from a calendared-based and fleet-optimized maintenance scheme to a predictive maintenance and unit-optimized strategy. The technology described herein is particularly well-suited for, but not limited to, performing predictive maintenance in industrial settings.

### BACKGROUND

In recent years, artificial intelligence has been applied to manage the maintenance of complex industrial systems, leveraging data collected from sensors and expert knowledge. The result is the development of a new paradigm of maintenance called “prognostics” or “predictive maintenance.” The goal of predictive maintenance is two-fold. First, predictive maintenance attempts to accurately forecast the remaining useful life of a component or a system. Second, predictive maintenance aims to guide maintenance decisions from the predicted health of the system. Implementations of predictive maintenance algorithms generally require a large amount of data sampled from all the operating conditions that the mechanical component could experience, especially environments close to the rupture points, before any mechanical failures.

Let us assume that a calendar-based maintenance paradigm is in place for a component C on a fleet F. The life time of C is defined globally based on lab tests and statistical considerations so that the worst case scenario will not occur in any system of F. By design this approach is very conservative and leads to mechanical components that are changed prematurely. Thus it drastically impacts and retrains the distribution of the operating data, removing from the sensor data points of a great interest that would reflect the behavior years/months before a natural end of life. This conservative behavior makes the switch from calendar-based to predictive maintenance even more challenging. It creates an important gap between the data available resulting from the old strategy and the data required to develop a prognostic model.

With conventional systems, two main approaches exist to switch to predictive maintenance of components. The first one is to develop the prognostic model off-production, from lab simulations. One or several components are used in lab to collect the data required with simulated environment, testing the physical limits of the component. The main advantage of this approach is that the lab simulations ensure that one can collect as much data as we needed, especially for ages greater than the actual fleet. The drawbacks of this method are the costs since units used for tests are not generating revenues, and that tested units are pushed to their limits and will not be usable for production afterward. Additionally, this method produces a prognostic model based on very small population of machines and simulated environments that do not reproduce all the real world environments encountered in the actual fleet. It drives to a weaken confidence in the model and should validated experimentally before any deployment. This validation step takes times and the calendar-based maintenance is still in use during this phase.

The second approach for predictive maintenance of components is to increase the lifetime of the component incrementally to step by step complete the distribution of the experimental data taken from the actual fleet. One can then develop an initial prognostic model. The decisions of pushing the lifetime further are based on lab testing of actual mechanical components reaching the end of the life time in place. The advantage is that the components used of the study are still used in production so it does not drive any revenue loss. However this approach is slow and requires lots of lab testing and analysis anytime a lifetime extension is needed. These intermediary results and efforts are outdated after each increment.

In each of the approaches described above, switching to the prognostics paradigm is a long process, costly and discontinuous. Accordingly, it is desired to provide an efficient way to switch from a calendared-based and fleet-optimized maintenance scheme to a predictive maintenance and unit-optimized strategy.

### SUMMARY

Embodiments of the present invention address and overcome one or more of the above shortcomings and drawbacks, by providing methods, systems, and apparatuses to address the switch from a calendared-based and fleet-optimized maintenance scheme to a predictive maintenance and unit-optimized strategy. The techniques described herein use predictive models and their orchestrations to guide the data collection that is required to develop fully functional prognostic models. As described above, in conventional systems, the data gathering step is driven either by recurrent extensions of the calendar-based models or by experimental measurements made in labs on isolated components. Unlike these conventional methods, the techniques described herein allow a smooth transition from calendar based maintenance to predictive maintenance where prognostics models are continuously trained and updated as data is generated.

According to some embodiments, a computer-implemented method for performing predictive maintenance includes executing a fleet prediction process. During this fleet prediction process, a plurality of fleet data records is collected. Each fleet data record comprises sensor data from a particular physical component in a fleet of physical components. A plurality of component maintenance predictions related to the fleet of physical components is generated. Each component maintenance prediction corresponds to a particular physical component. The plurality of component predictions are merged into one or more fleet maintenance predictions and the fleet maintenance predictions are presented to one or more users (e.g., via a visualization presented in a GUI or an e-mailed report). Following the fleet prediction process, a next execution of the fleet prediction process is scheduled based on the fleet maintenance predictions. This scheduling may be performed, for example, by entering a job request into a job queue.

Various enhancements, refinements, and other modifications may be made to the aforementioned method in different embodiments. For example, in one embodiment, the component maintenance prediction is generated for each physical component by generating maintenance predictions for a plurality of different temporal intervals and merging the maintenance predictions for the different temporal intervals to yield the component maintenance prediction. These temporal intervals may include, for example, short-term temporal interval, a medium-term temporal interval, and a long-term temporal interval. The maintenance predictions for each different temporal intervals may be generated, for example, using a prognostic model trained to a specific temporal interval.

According to another aspect of the present invention, a system for performing predictive maintenance comprises a sensor data database, a plurality of prognostic modules, and a fleet level controller. The sensor data database stores a plurality of fleet data records. Each fleet data record comprises sensor data from a particular physical component in a fleet of physical components. The prognostic modules are configured to generate a plurality of component maintenance predictions related to the fleet of physical components. Each prognostic module corresponds to a particular physical component. The fleet level controller merges the component predictions into fleet maintenance predictions and selects a future time for re-generating each of the component maintenance predictions. The fleet level controller is also configured to schedule a job to be executed at the future time to re-generate each of the component maintenance predictions.

Additional features and advantages of the invention will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there are shown in the drawings embodiments that are presently preferred, it being understood, however, that the invention is not limited to the specific instrumentalities disclosed. Included in the drawings are the following Figures:

FIG. 1A provides an functional architecture of software that can be used to implement the techniques described herein

FIG. 1B shows prognostic modules used by functional architecture show in FIG. 1A;

FIG. 2 shows flowchart of a controller process at a component level, according to some embodiments

FIG. 3 shows flowchart of a controller process at the fleet level, according to some embodiments;

FIG. 4 provides a flowchart of a computer-implemented method for performing predictive maintenance, according to some embodiments; and

FIG. 5 provides an example of a parallel processing memory architecture that may be utilized by to perform computations related to prognostic modeling, according to some embodiments of the present invention.

### DETAILED DESCRIPTION

Systems, methods, and apparatuses are described herein which relate generally to techniques switching from a calendared-based and fleet-optimized maintenance scheme to a predictive maintenance and unit-optimized strategy. Because the conventional calendar-based approach is by design very conservative, switching the maintenance paradigm to a predictive approach is particularly challenging. There is a lack of operating data available around critical behaviors (before any mechanical failure the algorithm should prevent). The techniques described herein allow the component to get closer to the risk zone while staying on the safe operating side. These techniques combine multiple levels of monitoring of the mechanical component and adapt the monitoring strategy given the observed and predicted health of the component. The techniques described herein continuously and smoothly collect the data required for the development of a predictive model while learning a wear forecasting model that will support predictive maintenance and shape the prognostic models targeted.

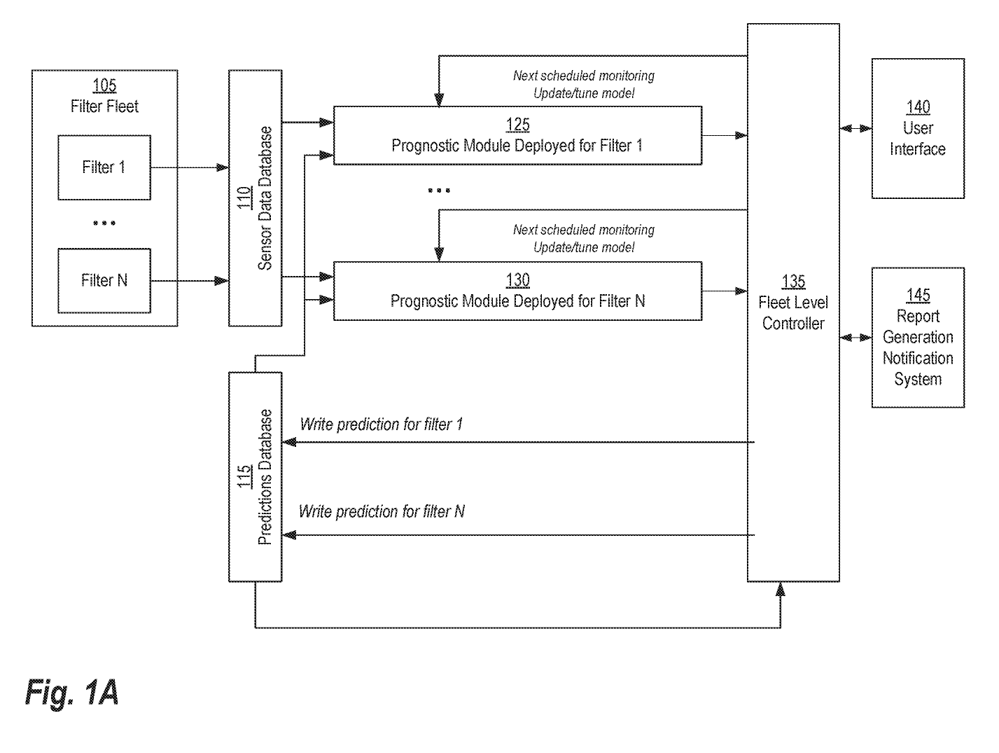

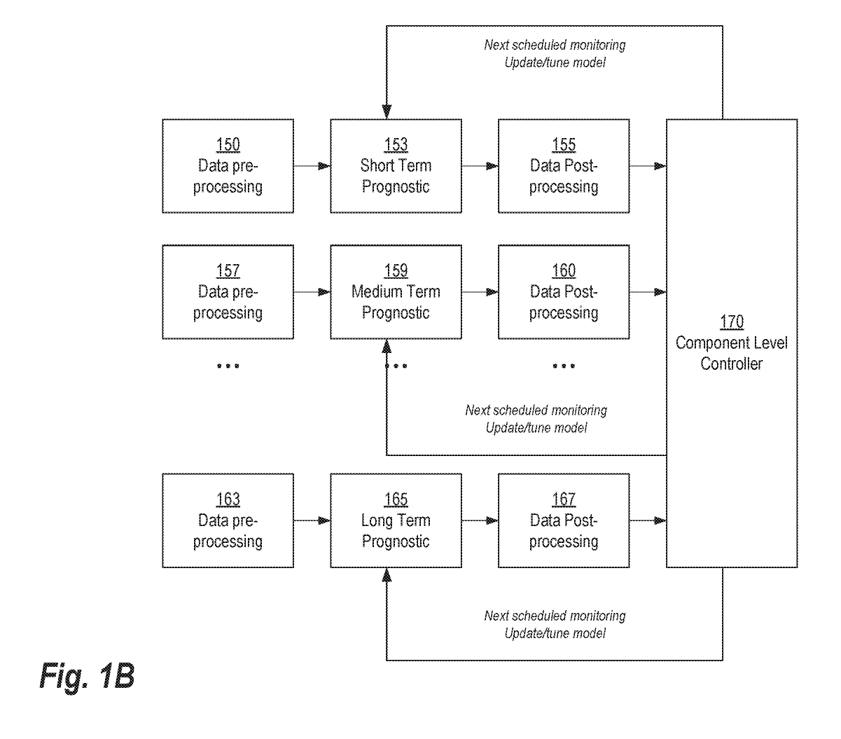

FIG. 1A provides a functional architecture of software that can be used to implement the techniques described herein. In this example, the maintenance scheme is managed with respect to a fleet of filters 105. This fleet of filters 105 may include, for example, oil filters for a fleet of automobiles. Each filter has one or more sensors that collect data from the filter and stores it in a sensor data database 110. To continue with the oil filter example, an automobile may include one or more sensors that monitor data such as oil viscosity. Aside from filter-specific data, other related data may be stored in the sensor data database 110 (e.g., vibration, temperature, etc.). The sensor data may be transferred between the filter fleet 105 and the sensor data database 110 using any technique known in the art. For example, in some embodiments, each filter 1 may be monitored using sensors that are able to wirelessly transfer data to the sensor data database 110 at predetermined intervals (e.g., daily). In other embodiments, a human user may manually collect the sensor data and enter it into the sensor data database 110. It should be understood that communication between the filter fleet 105 and the sensor data database 110 is performed using one or more computing systems (not shown in FIG. 1 for clarity).

Data from the sensor data database 110 are used as input into a plurality of prognostic modules (e.g., prognostic module 125 and 130). Each prognostic module corresponds to one of the filters in the filter fleet 105. An example implementation of a prognostic module is shown in FIG. 1B. Briefly, a series of prognostic models are used to predict the wear of the mechanical component at the different time scales. Given a threshold set by expert, remaining useful life may be determined. In order to develop the prognostic models, the prognostic module leverages and maximizes the usage of sensor data for each mechanical component in the fleet. The models themselves are generic; however, once deployed for a specific unit, the models learn the characteristics of the unit (manufacture and environmental-based) and acquire unique differentiations. This architecture allows a continuous learning and improvement a long term forecasting model while applying a strict and short term monitoring whenever the mechanical component requires closer attention. Short term monitoring ensures that the mechanical component is stopped before any failure. Thus, while learning predictive models, the age of the mechanical component can be pushed closer to its theoretical end of life while never placing the component at risk. This approach is progressively collecting data from the complete operational conditions distribution, with no off-site testing and directly on the global fleet. The mechanical components used to collect the data and learn the prognostic models can stay in production and will stay in service after the development models.

As shown in FIG. 1B, each prognostic module comprises a plurality of software components that make predictions on various time levels. In this example, three time levels are shown. Components 150, 153, and 155 provide predictions on a short term basis; components 157, 159, and 160 provide predictions on a medium term basis; and components 163, 165, and 167 provide predictions on a long term basis. It should be understood that more time levels may be captured, depending on the desired granularity of the predictions.

Various types of models generally known in the art may be used in implementing the prognostic models. Each prognostic model addresses a forecasting problem that is mathematically different from the others. The accuracy desired and the data available is drastically different for short term and long terms problems. The approach employed by the prognostic module optimizes the leverage of the sensor data in predictive models. Long-term has initially very few data available and shallow machine learning algorithms can developed whereas short term forecasting initially has a large amount of data and deep learning approaches can be used here.

The prognostic module shown in FIG. 1B is centered on an optimized leverage of the sensor data. The use of short term predictive model and the orchestration with other modes ensure the mechanical components age is pushed to complete the sensor data while avoiding any failure or wear-related break points. The mode instances, tailored by component, extract the maximum amount of data from each unit. When a component can be run for longer time given its history, it is kept in place which helps the generation useful data samples. It is renewed only when needed and avoids conservative mechanical component changes that would be triggered between to intermediate studies.

Each set of components shown in FIG. 1B includes a data pre-processing component that performs tasks such as extracting the data from the sensor data database 110, transforming the data into a format suitable for making the desired prediction, and loading the data into the prognostic component. Once the prognostic component makes its prediction, a data post-processing component extracts the data from the prognostic module, performs any necessary transformations, and loads into a component level controller 170.

The component level controller 170 dynamically orchestrates the interaction between different levels given the feedbacks collected at the unit level solely. It can order the modification of the monitoring schedule (i.e. ordering short term monitoring when the output of the long forecasting predicts unstable behaviors) or enforce the update of a model (retraining, tuning, etc.). For example, if the predictions indicate that the filter is close to end of life, the rate of monitoring can be increased.

Returning to FIG. 1A, the prediction data generated by each prognostic model is gathered into a fleet level controller 135. Briefly, fleet level controller 135 takes actions that are similar to those performed by the component level controller 170, but the fleet level controller 135 analyzes performance at the fleet level, comparing units with each other.

The fleet level controller 135 writes predictions for each filter into a prediction database 115 for later use by each prognostic module in making performance assessment. Additionally, the fleet level controller 135 makes fleet level decisions on how to schedule monitoring and prognostic model updating. For example, based on the prediction generated by the prognostic module deployed filter 1 (i.e., prognostic module 125), the fleet level controller 135 may determine that the prognostic model used by the prognostic module deployed the other filters also needs to be updated.

The fleet level controller 135 may additionally provide a reporting of predictions for the fleet to a user interface 140 (e.g., a desktop computer, smart phone, or tablet). At the user interface 140, the models performances can be visualized on demand at a unit, sub fleet or fleet level. Additionally, via the user interface 140, the user can also enforce a modification of the monitoring schedule and updates/tuning of a model.

The fleet level controller 135 may also interact with a report generation notification system 145 that generate reports with prediction information and other contextual information useful in understanding the predictions. Once generated, the reports can be stored for later review or sent to a user. The decision of how to generate and send the report may be based, for example, on predefined rules. For example, in one embodiment, the report generation notification system 145 generates an email for each report and sends the email to one or more individuals tasked with monitoring the filter fleet 105.

The approach described above with respect to FIGS. 1A and 1B reduces the development time required to collect and produce prognostic models when the calendar based maintenance is in place. With the leaner process exposed above, structural time is saved with the omission of intermediates analysis and the normalization of communications with third parties. An additional time savings comes in model generation: as soon as the data collected is sufficient, the prognostic model is already developed and in validation. Moreover, the leaner process of training and updating the models contributes to lower the development cost since it eliminates intermediary analysis or lab tests done through third parties.

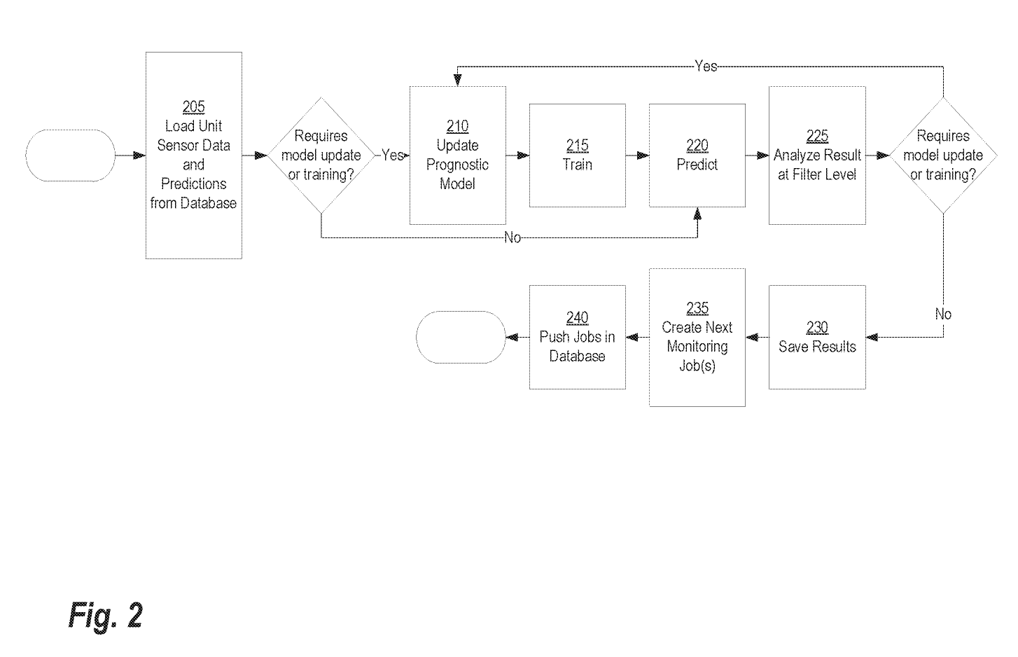

FIG. 2 shows a flowchart of a controller process at a component level, according to some embodiments. The process illustrated in this example is part of the processing performed by the component level controller 170 in FIG. 1B. Starting at step 205, unit sensor data and predictions are loaded from their respective databases (see FIG. 1A). Next, the controller process determines whether the model needs updating or training. For example, during first execution of the process, the model would need to be trained. Then, at scheduled time intervals or as otherwise specified the model is updated. Assuming that updating/training is required, the prognostic model is first updated at step 210. Then, the model is trained at step 215 and a prediction is generated at step 220. At step 225, the predicted result is analyzed at the filter level and the process determines if additional updating or training is required. If so, the process repeats at step 210.

Continuing with reference to FIG. 2, if additional updating/training is not required, the results of the prediction are saved in the predictions database at step 230. The next monitoring jobs are then created at step 235 before being stored in a jobs database at 240. Thereafter, the computing system performing component monitoring may remove jobs from the queue and execute them during normal processing.

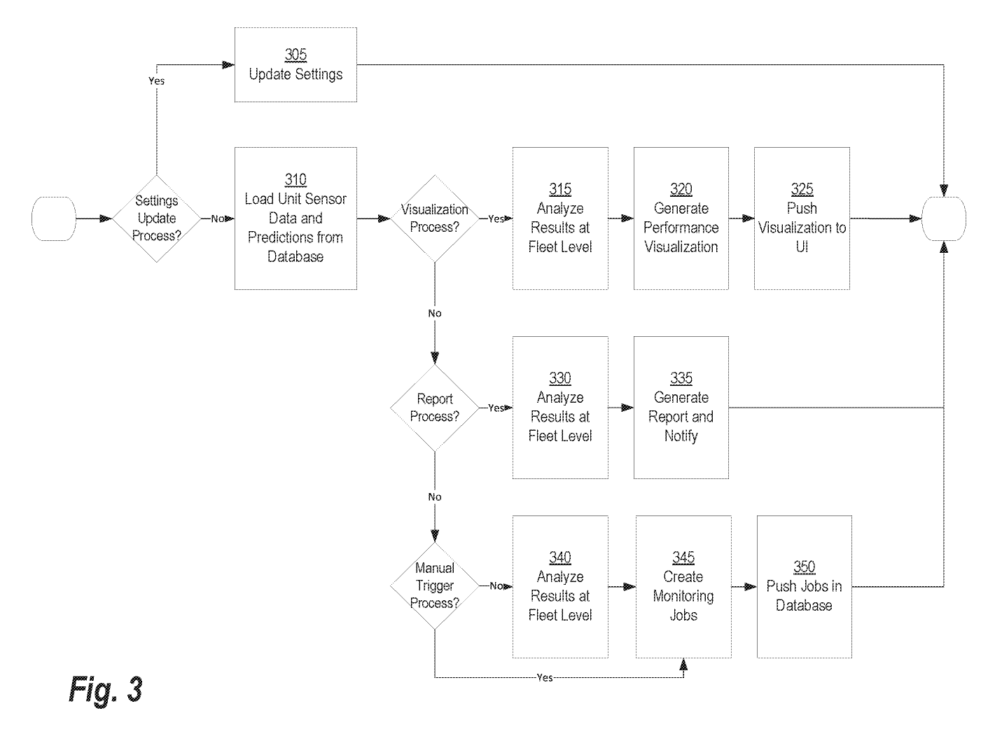

FIG. 3 shows a flowchart of a controller process at the fleet level, according to some embodiments. The process illustrated in this example is part of the processing performed by the fleet level controller 135 in FIG. 1A. The controller executes a queue of processes and a series of steps are conditionally executed based on the requirements of the process. For example, if the process is to update settings, settings are updated at step 305. If the process is not an update settings process, then unit sensor data and predictions are loaded from their respective databases at step 310. For a visualization process, the prognostic results are analyzed at the fleet level at step 315 and a performance visualization at step 320. Then, the visualization is pushed to the user interface at step 325. For a report process, the prognostic results are analyzed at step 330, before generating a report and notifying one or more users at step 335. Finally, for a manual trigger process, the prognostic results are analyzed at step 340 and one or more monitoring jobs are created at step 345. Then, the created jobs are pushed to the jobs database at step 350.

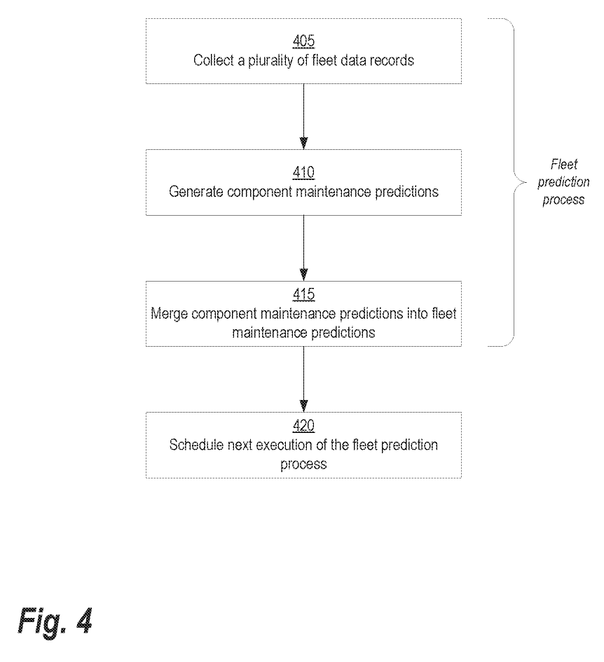

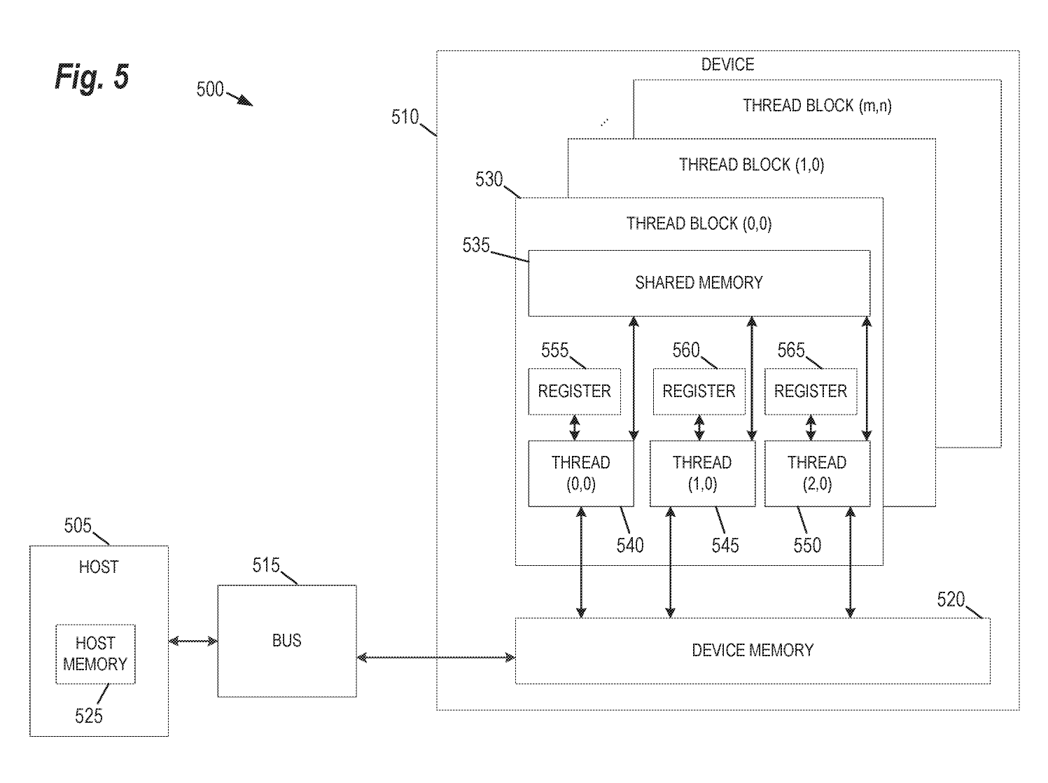

FIG. 4 provides a flowchart of a computer-implemented method for performing predictive maintenance, according to some embodiments. The method shown in FIG. 4 offers an example of how the concepts described above with reference to FIGS. 1A-3 may be applied. This method may be performed, for example, by the computing system illustrated in FIG. 5 or in similar computing systems generally known in the art.

Starting at step 405, a plurality of fleet data records are collected, for example, from the sensor data database (see FIG. 1A). Each fleet data record comprises sensor data from a particular physical component in a fleet of physical components. Next, at step 410, the computing system generates component maintenance predictions related to the fleet of physical components. Each component maintenance prediction corresponds to a particular physical component. These component maintenance predictions may be generated, for example, using the prognostic module described above with reference to FIG. 1B.

As noted above with reference to FIG. 1B, each component maintenance prediction may be generated by generating maintenance predictions for a plurality of different temporal intervals and merging the maintenance predictions for the different temporal intervals to yield the component maintenance prediction. The temporal intervals may include, for example, a short-term temporal interval, a medium-term temporal interval, and a long-term temporal interval. The term “merging” in this context may be simple aggregation or, in some embodiments, a more complex integration of the data is used. For example, in one embodiment, the component predictions are merged by applying a weighting average of the data with weights determined by length of the time interval associated with the data. Thus, short-term predictions may be weighted heavier than long-term predictions.

At step 415, the component predictions are merged into one or more fleet maintenance predictions. As with the component-level merging of data, data may be merged at the fleet level through simple aggregation or, in some embodiments, using more complex integration techniques. For example, in one embodiment, the component predictions are merged by applying a weighting average of the data with weights determined by the age of the physical component. Thus, the data associated with relatively old components predictions may be weighted heavier than younger components.

Then, at step 420, the fleet maintenance predictions are presented to one or more users. In some embodiments, presentation of the predictions entails generating a visualization of the fleet maintenance predictions and presenting the visualization in a graphical user interface. In other embodiments, a report describing the fleet maintenance predictions may be generated using report generation techniques generally known in the art. Then, one or more recipients for the report are selected based pre-determined rules related to the fleet and the report is sent to the recipients, for example, using email. The pre-determined rules may set by the system administrator or another authorized user and specify information such as which individuals should receive reports and how frequently they should be transmitted.

Steps 405-415 are referred to herein as “a fleet prediction process.” This fleet prediction process may include other steps not shown in FIG. 4 (e.g., re-training the prognostic models). At step 420, the next execution of the fleet prediction process is scheduled based on the fleet maintenance predictions. For example, if the fleet maintenance predictions indicate that a physical component is close to end-of-life or will require maintenance soon, the next prediction may be scheduled to be performed in the relatively near future. The technique applied for scheduling will depend on the software architecture in which the method shown in FIG. 4 is executed. For example, in one embodiment, a job request to re-execute the fleet prediction process based on the fleet maintenance predictions. Then, this job request is entered into a job queue. A scheduler will remove and execute jobs by the queue one-by-one over time.

FIG. 5 provides an example of a parallel processing memory architecture 500 that may be utilized by to perform computations related to prognostic modeling, according to some embodiments of the present invention. This architecture 500 may be used in embodiments of the present invention where NVIDIA™ CUDA (or a similar parallel computing platform) is used. The architecture includes a host computing unit (“host”) 505 and a GPU device (“device”) 510 connected via a bus 515 (e.g., a PCIe bus). The host 505 includes the central processing unit, or “CPU” (not shown in FIG. 5) and host memory 525 accessible to the CPU. The device 510 includes the graphics processing unit (GPU) and its associated memory 520, referred to herein as device memory. The device memory 520 may include various types of memory, each optimized for different memory usages. For example, in some embodiments, the device memory includes global memory, constant memory, and texture memory.

Parallel portions of a deep learning application may be executed on the architecture 500 as “device kernels” or simply “kernels.” A kernel comprises parameterized code configured to perform a particular function. The parallel computing platform is configured to execute these kernels in an optimal manner across the architecture 500 based on parameters, settings, and other selections provided by the user. Additionally, in some embodiments, the parallel computing platform may include additional functionality to allow for automatic processing of kernels in an optimal manner with minimal input provided by the user.

The processing required for each kernel is performed by a grid of thread blocks (described in greater detail below). Using concurrent kernel execution, streams, and synchronization with lightweight events, the architecture 500 of FIG. 5 (or similar architectures) may be used to parallelize training of a deep neural network. For example, in some embodiments, the prognostic modules (see FIG. 1A) execute models for different time intervals (e.g., short-term, mid-term, etc.) simultaneously on a set of sensor data. In some embodiments, the component or fleet level controller may also be implemented such that various operations performed with solving the system are done in parallel.

The device 510 includes one or more thread blocks 530 which represent the computation unit of the device 510. The term thread block refers to a group of threads that can cooperate via shared memory and synchronize their execution to coordinate memory accesses. For example, in FIG. 5, threads 540, 545 and 550 operate in thread block 530 and access shared memory 535. Depending on the parallel computing platform used, thread blocks may be organized in a grid structure. A computation or series of computations may then be mapped onto this grid. For example, in embodiments utilizing CUDA, computations may be mapped on one-, two-, or three-dimensional grids. Each grid contains multiple thread blocks, and each thread block contains multiple threads. For example, in FIG. 5, the thread blocks 530 are organized in a two dimensional grid structure with m+1 rows and n+1 columns. Generally, threads in different thread blocks of the same grid cannot communicate or synchronize with each other. However, thread blocks in the same grid can run on the same multiprocessor within the GPU at the same time. The number of threads in each thread block may be limited by hardware or software constraints. In some embodiments, processing of subsets of the sensor data or operations performed by the prognostic models may be partitioned over thread blocks automatically by the parallel computing platform software. However, in other embodiments, the individual thread blocks can be selected and configured to optimize modeling. For example, in one embodiment, each thread block is assigned a subset of sensor data with overlapping values.

Continuing with reference to FIG. 5, registers 555, 560, and 565 represent the fast memory available to thread block 530. Each register is only accessible by a single thread. Thus, for example, register 555 may only be accessed by thread 540. Conversely, shared memory is allocated per thread block, so all threads in the block have access to the same shared memory. Thus, shared memory 535 is designed to be accessed, in parallel, by each thread 540, 545, and 550 in thread block 530. Threads can access data in shared memory 535 loaded from device memory 520 by other threads within the same thread block (e.g., thread block 530). The device memory 520 is accessed by all blocks of the grid and may be implemented using, for example, Dynamic Random-Access Memory (DRAM).

Each thread can have one or more levels of memory access. For example, in the architecture 500 of FIG. 5, each thread may have three levels of memory access. First, each thread 540, 545, 550, can read and write to its corresponding registers 555, 560, and 565. Registers provide the fastest memory access to threads because there are no synchronization issues and the register is generally located close to a multiprocessor executing the thread. Second, each thread 540, 545, 550 in thread block 530, may read and write data to the shared memory 535 corresponding to that block 530. Generally, the time required for a thread to access shared memory exceeds that of register access due to the need to synchronize access among all the threads in the thread block. However, like the registers in the thread block, the shared memory is typically located close to the multiprocessor executing the threads. The third level of memory access allows all threads on the device 510 to read and/or write to the device memory. Device memory requires the longest time to access because access must be synchronized across the thread blocks operating on the device. Thus, in some embodiments, the processing of each set of sensor values is coded such that it primarily utilizes registers and shared memory and only utilizes device memory as necessary to move data in and out of a thread block.

The embodiments of the present disclosure may be implemented with any combination of hardware and software. For example, aside from parallel processing architecture presented in FIG. 5, standard computing platforms (e.g., servers, desktop computer, etc.) may be specially configured to perform the techniques discussed herein. In addition, the embodiments of the present disclosure may be included in an article of manufacture (e.g., one or more computer program products) having, for example, computer-readable, non-transitory media. The media may have embodied therein computer readable program code for providing and facilitating the mechanisms of the embodiments of the present disclosure. The article of manufacture can be included as part of a computer system or sold separately.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof. No claim element herein is to be construed under the provisions of 35 U.S.C. 112, sixth paragraph, unless the element is expressly recited using the phrase “means for.”

1. A computer-implemented method for performing predictive maintenance, the method comprising:
executing a fleet prediction process comprising:
collecting a plurality of fleet data records, wherein each fleet data record comprises sensor data from a particular physical component in a fleet of physical components;
generating a plurality of component maintenance predictions related to the fleet of physical components, wherein each component maintenance prediction corresponds to a particular physical component;
merging the plurality of component predictions into one or more fleet maintenance predictions;
presenting the fleet maintenance predictions to one or more users; and
scheduling a next execution of the fleet prediction process based on the fleet maintenance predictions.

2. The method of claim 1, wherein the component maintenance prediction is generated for each physical component by a process comprising:
receiving the fleet data record corresponding to the physical component;
generating maintenance predictions for a plurality of different temporal intervals;
merging the maintenance predictions for the different temporal intervals to yield the component maintenance prediction.

3. The method of claim 2, wherein the plurality of different temporal intervals comprise a short-term temporal interval, a medium-term temporal interval, and a long-term temporal interval.

4. The method of claim 2, the maintenance predictions for the different temporal intervals are each generated using a prognostic model trained to a specific temporal interval.

5. The method of claim 4, further comprising:
scheduling updating or training of each prognostic model based on the component maintenance prediction.

6. The method of claim 4, further comprising:
scheduling updating or training of each prognostic model based on the fleet maintenance prediction.

7. The method of claim 1, wherein presenting the fleet maintenance predictions to the users comprises:
generating a visualization of the fleet maintenance predictions; and
presenting the visualization in a graphical user interface.

8. The method of claim 1, wherein presenting the fleet maintenance predictions to the users comprises:
generating a report describing the fleet maintenance predictions; and
selecting one or more recipients for the report based pre-determined rules related to the fleet; and
transmitting the report to the one or more recipients.

9. The method of claim 8, wherein the report is transmitted by e-mail to each of the recipients.

10. The method of claim 1, wherein scheduling the next execution of the fleet prediction process based on the fleet maintenance predictions comprises:
creating a job request to re-execute the fleet prediction process based on the fleet maintenance predictions; and
entering the job request into a job queue.

11. The method of claim 1, further comprising:
in response to presenting the fleet maintenance predictions to the users, receiving a request from at least one user to re-execute the fleet prediction process;
creating a job request to re-execute the fleet prediction process; and
entering the job request into a job queue.

12. A system for performing predictive maintenance, the system comprising:
a sensor data database storing a plurality of fleet data records, wherein each fleet data record comprises sensor data from a particular physical component in a fleet of physical components;
a plurality of prognostic modules configured to generate a plurality of component maintenance predictions related to the fleet of physical components, wherein each prognostic modules corresponds to a particular physical component;
a fleet level controller configured to:
merge the plurality of component predictions into one or more fleet maintenance predictions,
select a future time for re-generating each of the plurality of component maintenance predictions, and
schedule a job to be executed at the future time to re-generate each of the plurality of component maintenance predictions.

13. The system of claim 12, further comprising:
a predictions database,
wherein the fleet level controller is further configured to store the plurality of component maintenance predictions in the predictions database, and
wherein prognostic modules generate the plurality of component maintenance predictions using component maintenance predictions stored in the predictions database.

14. The system of claim 12, further comprising a user interface configured to:
generate a visualization of the fleet maintenance predictions; and
present the visualization in a graphical user interface.

15. The system of claim 12, further comprising a report generation notification system configured to:
generate a report describing the fleet maintenance predictions; and
select one or more recipients for the report based pre-determined rules related to the fleet; and
transmit the report to the one or more recipients.

16. The system of claim 15, wherein the report is transmitted by e-mail to each of the recipients.

17. The system of claim 12, wherein each prognostic module comprises:
one or more data pre-processing components configured to receive the fleet data record corresponding to the physical component;
a plurality of prognostic models configured to generate maintenance predictions for a plurality of different temporal intervals;
a component level controller configured to merge the maintenance predictions for the different temporal intervals to yield the component maintenance prediction.

18. The system of claim 17, wherein the plurality of different temporal intervals comprise a short-term temporal interval, a medium-term temporal interval, and a long-term temporal interval.

19. The system of claim 17, wherein the plurality of prognostic models are executed in parallel using a parallel processing memory architecture.

20. An article of manufacture for performing predictive maintenance, the article of manufacture comprising a non-transitory, tangible computer-readable medium holding computer-executable instructions for performing a method comprising:
executing a fleet prediction process comprising:
collecting a plurality of fleet data records, wherein each fleet data record comprises sensor data from a particular physical component in a fleet of physical components;
generating a plurality of component maintenance predictions related to the fleet of physical components, wherein each component maintenance prediction corresponds to a particular physical component;
merging the plurality of component predictions into one or more fleet maintenance predictions;
presenting the fleet maintenance predictions to one or more users; and
scheduling a next execution of the fleet prediction process based on the fleet maintenance predictions.
